(19) United States
(12) Patent Application Publication
(10) Pub. No.: US 2004/0006633 A1
(43) Pub. Date: Jan. 8, 2004

(54) High-speed multi-processor, multi-thread queue implementation

(75) Inventors: Prashant R. Chandra, Sunnyvale, CA (US); Larry Bruce Huston, San Jose, CA (US)

Correspondence Address: KENYON & KENYON, 1500 K STREET, N.W., SUITE 700, WASHINGTON, DC, 20005, US

(73) Assignee: Intel Corporation

(21) Appl. No.: 10/188,401

(22) Filed: Jul. 3, 2002

(51) Int. Cl. G06F 15/16

(52) U.S. Cl. 709/231

(57) ABSTRACT

A method and system of enqueueing and dequeueing packets in a multi-threaded environment provide enhanced speed and performance. An availability of a queue is determined, where the queue is shared by a plurality of receive threads and has an associated produce index. If the queue is determined to be available, the produce index is incremented while the produce index is locked. On the other hand, an incoming packet is written to the queue while the produce index is unlocked. It is further determined whether data is stored in a queue of an off-chip memory of a network processor based on a produce count and a consume count. The produce count and the consume are stored in an on-chip memory of the network processor.

### CROSS REFERENCE TO RELATED APPLICATIONS

The present application is related to the U.S. patent application of Prashant R. Chandra et al. entitled “Efficient Multi-Threaded Multi-Processor Scheduling Implementation,” filed Jun. 14, 2002.

### BACKGROUND

1. Technical Field

Embodiments of the present invention generally relate to computer processors. More particularly, embodiments relate to enqueueing and dequeueing network data.

2. Discussion

In the highly competitive computer industry, the trend toward faster processing speeds and increased functionality is well documented. While this trend is desirable to the consumer, it presents significant challenges to processor designers as well as manufacturers. A particular challenge relates to the processing of packets by network processors. For example, a wide variety of applications such as multi-layer local area network (LAN) switches, multi-protocol telecommunications products, broadband cable products, remote access devices and intelligent peripheral component interconnect (PCI version 2.2, PCI Special Interest Group) adapters use one or more network processors to receive and transmit packets/cells/frames. Network processors typically have one or more microengine processors optimized for high-speed packet processing. Each microengine has multiple hardware threads. A network processor also typically has a general purpose processor on chip. Thus, in a network processor, a receive thread on a microengine will often transfer each packet from a receive buffer of the network processor to one of a plurality of queues contained in a relatively slow off-chip memory. The process of transferring packets to the queues is often referred to as “enqueueing.” Queue descriptor data is stored in a somewhat faster off-chip memory.

Each queue may have an associated type of service (TOS) ranging from network control, which typically has the highest priority to best-effort TOS, which often has the lowest priority. Information stored in the packet headers can identify the appropriate TOS for the packet to obtain what is sometimes referred to as “differentiated service” approach.

Once the packets are assembled in the slower off-chip memory, either the general purpose on-chip processor, or one or more micro-engines classify and/or modify the packets for transmission back out of the network processor. A micro-engine transmit thread determines the queues from which to consume packets based on queue priority and/or a set of scheduling rules. The process of transferring packets from the queues is often referred to as “dequeueing.” A number of techniques have evolved in recent years in order to enqueue and dequeue the packets.

One approach is shown generally in FIG. 4A at method 120. It can be seen that an availability of a queue is determined at processing block 122, where the queue is shared by a plurality of receive threads and has an associated produce index. Block 124 provides for writing an element such as a packet to the queue while the produce index is locked. The terms “element” and “packet” are used herein interchangeably. The produce index is incremented while the produce index is locked at block 126. Locking the produce index is done because multiple threads/processors can enqueue simultaneously and it is necessary for the queue implementation to be multiproducer safe. Thus, while a produce index of a particular queue is locked by a given receive thread, other receive threads cannot access the produce index or write to the queue. The time during which a produce index is locked can therefore be viewed as a “critical section” of the processing pipeline for the produce index. Simply put, critical sections act as points of serialization, where the result is a limit on the throughput of the enqueue operations. There is therefore a need to minimize the number and complexity of operations performed while the produce index is locked in an effort to reduce and/or simplify the critical section.

FIG. 4B shows the conventional approach to determining the availability of a shared queue in greater detail at block 122′. Specifically, block 128 provides for locking and reading the produce index, which is traditionally stored in a relatively slow off-chip memory. The consume index is read at block 130 from the slower off-chip memory and the space available is calculated at block 132. Although the other off-chip memory can generally be accessed at a faster rate than the slower off-chip memory, as network speeds increase the operations at blocks 128 and 130 can begin to contribute significantly to packet processing overhead. There is therefore a need for an approach to determining availability of a shared queue that is not subject to the latency concerns associated with conventional approaches.

### BRIEF DESCRIPTION OF THE DRAWINGS

The various advantages of embodiments of the present invention will become apparent to one skilled in the art by reading the following specification and appended claims, and by referencing the following drawings, in which:

FIG. 1 is a block diagram of an example of a networking architecture in accordance with one embodiment of the invention;

FIG. 2 is a block diagram of an example of a network processor and off-chip memories in accordance with one embodiment of the invention;

FIG. 3 is a block diagram of an example of a on-chip memory in accordance with one embodiment of the invention;

FIG. 4A is a flowchart of an example of a conventional method of processing packets;

FIG. 4B is a flowchart of an example of a conventional process of determining an availability of a shared queue;

FIG. 5 is a flowchart of an example of a flowchart of an example of a method of enqueueing packets in accordance with one embodiment of the invention;

FIG. 6 is a flowchart of an example of a process of determining an availability an availability of a shared queue in accordance with one embodiment of the invention;

FIG. 7 is a flowchart of an example of a process of incrementing a produce index in accordance with one embodiment of the invention;

FIG. 8 is a flowchart of an example of a process of writing an element to a queue in accordance with one embodiment of the invention;

FIG. 9 is a flowchart of an example of a method of dequeueing packets in accordance with one embodiment of the invention; and

FIG. 10 is a flowchart of an flowchart of an example of a process of determining whether data is in a shared queue in accordance with one embodiment of the invention.

### DETAILED DESCRIPTION

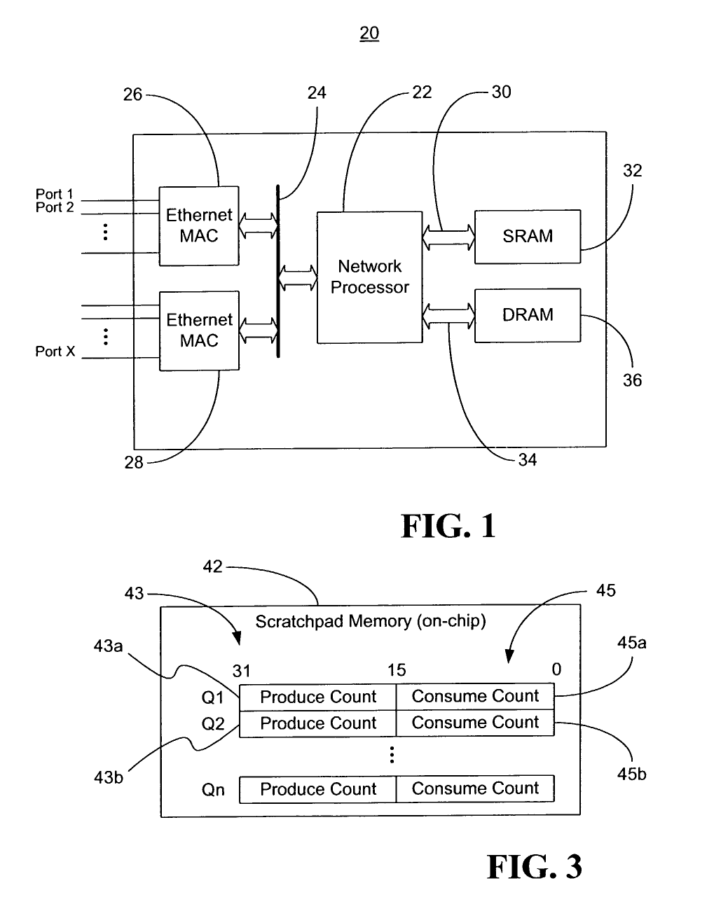

FIG. 1 shows a networking blade architecture 20 in which a network processor 22 communicates over a bus 24 with a number of Ethernet media access controllers (MACs) 26, 28 in order to classify, modify and otherwise process packets presented at ports 1-X. The network processor 22 also communicates over static random access memory (SRAM) bus 30 with SRAM 32, and over synchronous dynamic RAM (SDRAM) bus 34 with SDRAM 36. Although Ethernet MACs (Institute of Electrical and Electronics Engineers, 802.3) are illustrated, it should be noted that other network processing devices may be used. Furthermore, although SRAM 32 and SDRAM 36 are shown, other types of storage media are possible. For example, the network processor 22 may communicate with erasable programmable read only memory (EPROM), electronically EPROM (EEPROM), flash memory, hard disk, optical disk, magneto-optical disk, compact disk read only memory (CDROM), digital versatile disk (DVD), non-volatile memory, or any combination thereof without parting from the principles discussed herein.

Thus, the architecture 20 can be used in a number of applications such as routers, multi-layer local area network (LAN) switches, multi-protocol telecommunications products, broadband cable products, remote access devices, and intelligent peripheral component interconnect (PCI) adapters, etc. While the examples described herein will be primarily discussed with regard to Internet protocol (IP) packet routing, it should be noted that the embodiments of the invention are not so limited. In fact, the embodiments can be useful in asynchronous transfer mode (ATM) cell architectures, framing architectures, and any other networking application in which performance and Quality of Service (QoS) are issues of concern.

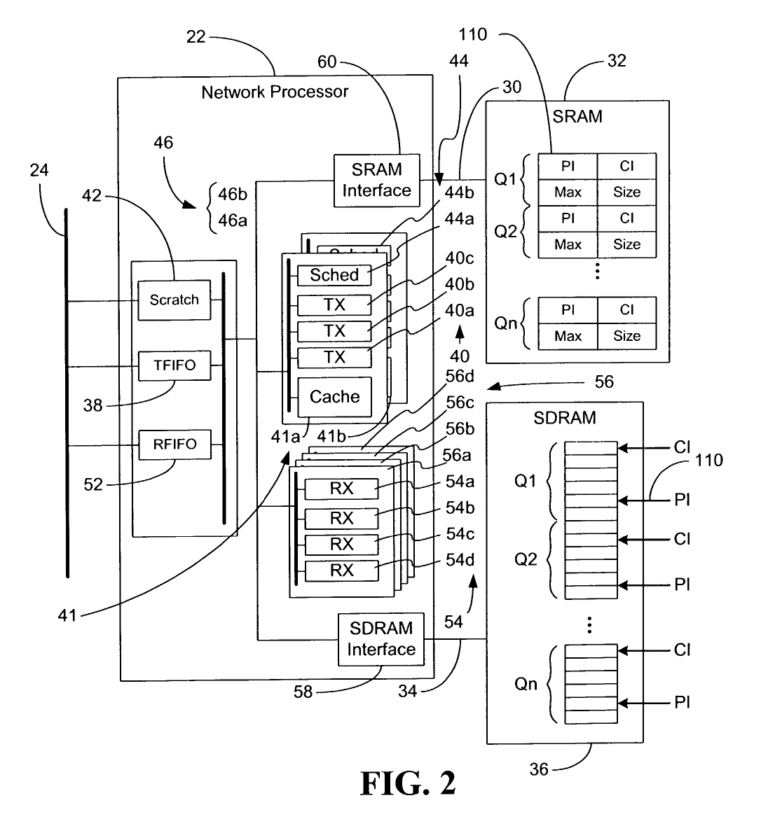

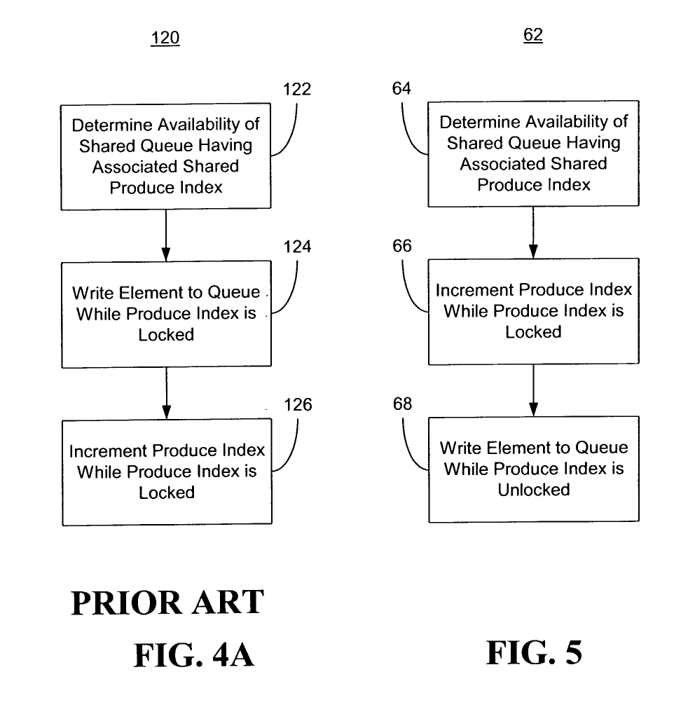

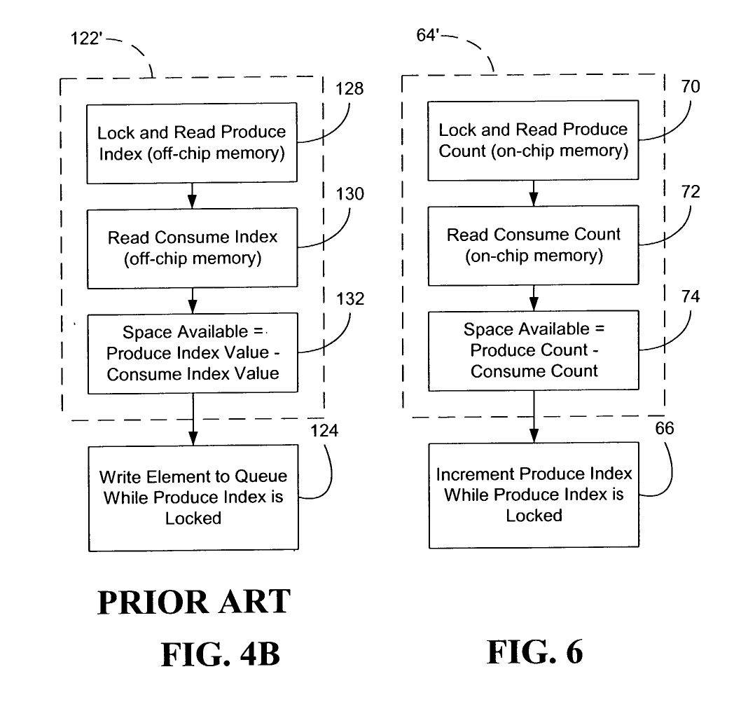

Turning now to FIG. 2, one approach to the architecture associated with network processor 22 is shown in greater detail. Generally, the network processor 22 has a plurality receive micro-engines 56, such as receive micro-engines 56a-56d, to use a plurality of receive threads 54, such as receive threads 54a-54d, to determine availability of a plurality of queues in order to enqueue incoming packets. The queues are indicated by Q1, Q2-Qn, where each queue is shared by the plurality of receive threads 54, and each queue has an associated produce index (PI). The produce indices, along with corresponding consume indices, are often referred to as “queue descriptors” and are stored in off-chip memory SRAM 32. By way of example, receive micro-engine 56a may use receive thread 54a to determine the availability of Q1, where Q1 has an associated produce index 110. If Q1 is determined to be available, the receive micro-engine 56a uses receive thread 54a to increment the produce index 110 while the produce index 110 is locked. The receive micro-engine 56a also uses receive thread 54a to write the incoming packet from a receive first in first out (RFIFO) buffer 52 to Q1 while the produce index 110 is unlocked. By writing the incoming packet to the queue while the produce index is unlocked, other receive threads may access the produce index and the critical section is reduced without sacrificing multiproducer safety.

As best shown in FIG. 3, the network processor 22 (FIG. 22) further includes an on-chip memory, scratchpad 42, operatively coupled to the receive micro-engines 56 (FIG. 2), where the scratchpad 42 stores a produce count 43, such as produce counts 43a, 43b, and a consume count 45, such as consume counts 45a, 45b for each queue. With continuing reference to FIGS. 2 and 3, it will be appreciated that the receive micro-engine 56a uses the receive thread 54a to determine the availability of Q1 based on the produce count 43a and the consume count 45a.

Thus, in the illustrated multi-threaded environment, sixteen receive threads 54 are partitioned into four receive micro-engines 56, and they all share the queues of SDRAM 36. By storing the produce counts 43 and the consume counts 45 on on-chip memory 42, the time required for each receive thread 54 to determine whether a particular queue is available can be significantly reduced. As such, the enqueue process can use on-chip memory to further increase speed.

Returning now to FIG. 2, networking processor 22 further includes a plurality of transmit micro-engines 46, such as transmit micro-engines 46a and 46b, which use a plurality of transmit threads 40, such as transmit threads 40a-40c, to dequeue packets from SDRAM 36 to a transmit FIFO (TFIFO) buffer 38. Specifically, each transmit micro-engine 46 uses a transmit thread 40 to determine whether data is stored in a particular queue based on a produce count and a consume count. For example, transmit micro-engine 46a may use transmit thread 40a to determine whether data is stored in Q1 based on produce count 43a (FIG. 3) and consume count 45a (FIG. 3). Thus, the dequeue process is also enhanced by storing the counts 43, 45 (FIG. 3) in on-chip scratchpad 42. It can be seen that the queues are shared by the plurality of transmit threads 40, which can be partitioned into the plurality of transmit micro-engines 46. Transmit micro-engines 46 may also include scheduler threads 44, such as scheduler threads 44a and 44b, to assign the transmit threads 40 to the queues.

Generally, the transmit micro-engines 46 use the transmit threads 40 to read multiple packets from the queues if data is determined to be stored in the queues. For example, transmit, micro-engine 46a may use transmit thread 40a to read multiple packets from Q1 if data is determined to be stored in Q1. In this regard, each transmit micro-engine 46 includes an on-chip cache 41, such as caches 41a and 41b. The transmit micro-engines 46 use the transmit threads 40 to determine whether data is stored in the on-chip cache 41 before determining whether data is stored in the queues. If data is determined to be stored in the on-chip cache 41, the transmit micro-engines 46 use the transmit threads 40 to read at least one outgoing packet from the on-chip cache 41. For example, transmit micro-engine 46a may use transmit thread 40a to determine whether data is stored in on-chip cache 41a before determining whether data is stored in Q1. If so, transmit micro-engine 46a uses transmit thread 40a to read at least one outgoing packet from on-chip cache from 41a in order to further reduce latencies. It should be noted that the network processor 22 is operatively coupled to the SDRAM 36 through SDRAM interface 58, and to SRAM 36 through SRAM interface 60.

Turning now to FIG. 5, one approach to enqueueing packets is shown generally at method 62. Method 62 can be implemented in any combination of commercially available hardware/software techniques. For example, a machine readable storage medium may store a set of instructions capable of being executed by a processor to implement any of the functions described herein. Generally, processing block 64 provides for determining an availability of a queue, where the queue is shared by a plurality of receive threads and has an associated produce index. If the queue is determined to be available, the produce index is incremented while the produce index is locked at block 66. Block 68 provides for writing a packet to the queue while the produce index is unlocked. As already discussed, by moving the functionality of block 68 out of the critical section, the speed of the multi-threaded architecture can be significantly increased.

Turning now to FIG. 6, the process of determining the availability of a queue is shown in greater detail at block 64′. Specifically, block 70 provides for locking and reading the produce count from an on-chip memory of the network processor. The consume count is read from the on-chip memory at block 72, and block 74 provides for determining the availability of the queue based on the produce count and the consume count. Specifically, the consume count is subtracted from the produce count.

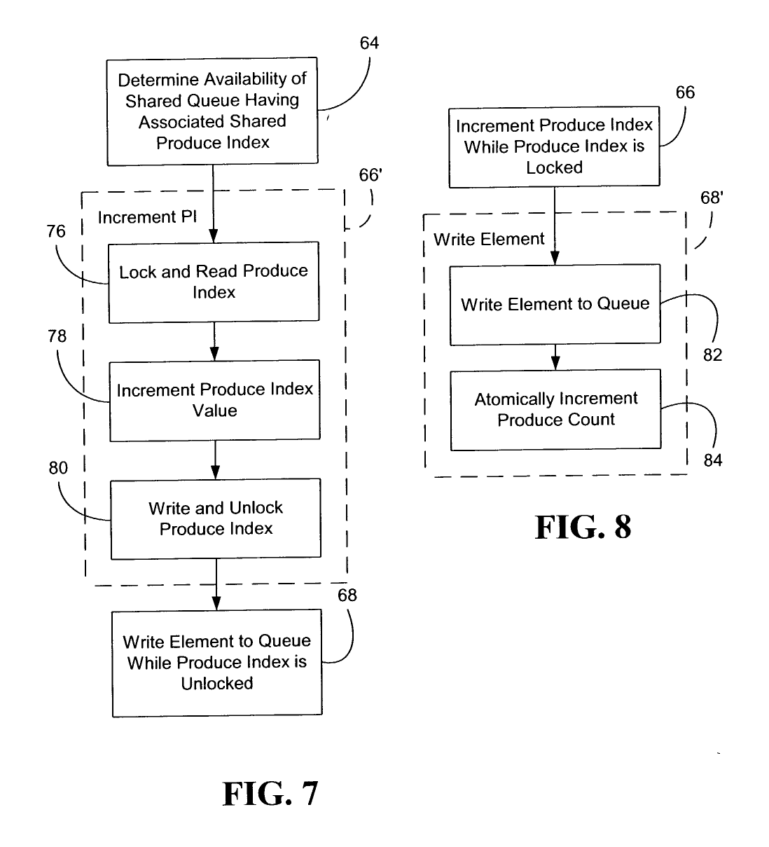

Turning now to FIG. 7, one approach to incrementing the produce index is shown in greater detail at block 66′. Specifically, block 76 provides for locking the produce index and reading a value of the produce index. The read value is incremented at block 78 by one. The incremented value is written to the produce index and the produce index is unlocked at block 80.

Turning now to FIG. 8, one approach to writing a packet to a queue is shown in greater detail at block 68′. Specifically, block 82 provides for writing the packet to the queue, and the appropriate produce count is atomically incremented at block 84. As already discussed, the produce count can be stored in an on-chip location.

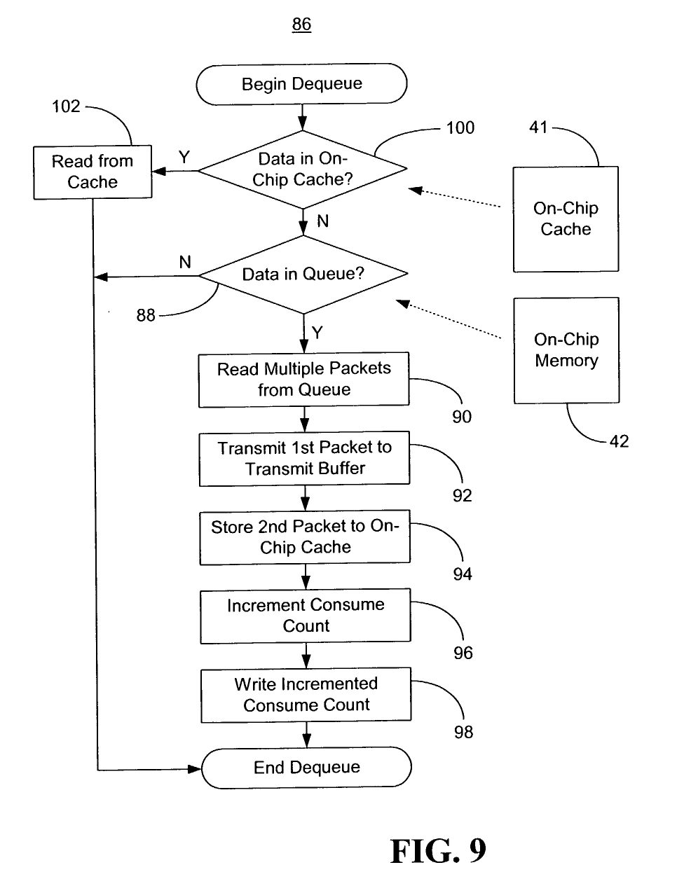

FIG. 9 shows one approach to dequeueing packets at method 86. Generally, it can be seen that block 88 provides for determining whether data is stored in a queue of an off-chip memory of a network processor based on a produce count and a consume count. The produce count and the consume count are stored in an on-chip memory 42 of the network processor. If data is determined to be stored in the queue, multiple packets are read from the queue at block 90. A first packet of the multiple packets is transmitted to a transmit buffer at block 92 and a second packet of the multiple packets is stored to an on-chip cache at block 41. Method 86 further provides for incrementing the consume count at block 96 in accordance with the reading of the multiple packets, and writing the incremented consume count to the on-chip memory 42 at block 98. It can further be seen that block 100 provides for determining whether data is stored in an on-chip cache before determining whether data is stored in the queue. If data is determined to be stored in the on-chip cache, block 102 provides for reading a packet from the on-chip cache. By implementing the cache in the dequeueing process, significant time savings can be achieved.

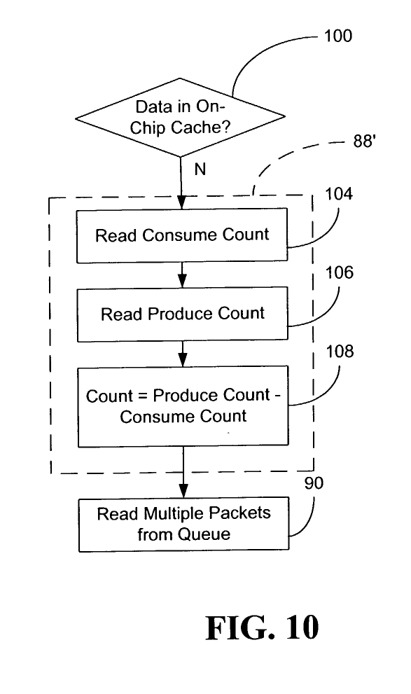

Turning now to FIG. 10, one approach to determining whether data is stored in the queue is shown in greater detail at block 88′. Specifically, block 104 provides for reading the consume count and block 106 provides for reading the produce count. The consume count is subtracted from the produce count at block 108. If the resulting count is greater than zero, then it is determined that data is in the queue.

Thus, the unique approaches discussed herein enable enqueueing and dequeueing of elements, packets, cells and/or frames to shared queues, and provide significant advantages over conventional techniques. For example, shortening the critical sections of the processing pipeline enables greater access in a multi-threaded environment. Furthermore, the use of readily accessible on-chip memory to store produce and consume counts reduces the need to access queue descriptors in off-chip memory. In addition, the implementation of on-chip caches allow transmit threads to further reduce latencies.

An example of detailed pseudo code for enqueue and dequeue operations is as follows:

ENQUEUE( )

{

Read produce and consume credit counts;
Queue size = produce credit count - consume credit count;
If queue empty, return error;
Read and lock the produce index;
Increment the produce index;
Write and unlock the produce index;
Pack buffer data and write to produce index location;
Atomically increment the produce credit count;

}
DEQUEUE( )
{

If (cached queue_count not equal to 0) {

Set cnt = cached queue_count;
Decrement cached queue_count

}
else {

Read produce and consume credit counts;
Set cnt = produce credit count - consume credit count;
If (cnt equal to 0)

Set cached queue_count = 0;

else

Set cached queue_count = cnt - 1;

}
if cnt is 0, return;
if (cache_valid is true) {

Set cache_valid to false;
Increment cached consume index;
Set consume credit count to consume index;
Unpack cached data;
Return data;

}
if (cnt is not equal to 1) {

Set cache _valid to true;
Read two queue entries starting from the cached consume
index;

}
else {

Set cache_valid to false;
Read one queue entry at the consume index;

}
Increment cached consume index;
Set consume credit count to consume index;
Unpack the first data entry;
Return data;

}

Those skilled in the art can now appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

In the claims:

1. A method of processing packets, comprising:
determining an availability of a queue, the queue being shared by a plurality of receive threads and having an associated produce index;
incrementing the produce index while the produce index is locked, if the queue is determined to be available; and
writing a packet to the queue while the produce index is unlocked.

2. The method of claim 1 further including:
reading a produce count from an on-chip memory of a network processor;
reading a consume count from the on-chip memory of the network processor; and
determining the availability of the queue based on the produce count and the consume count.

3. The method of claim 2 further including subtracting the consume count from the produce count.

4. The method of claim 2 wherein the queue is part of a first off-chip memory and the produce index is stored in a second off-chip memory.

5. The method of claim 4 wherein the first off-chip memory is a dynamic random access memory (DRAM) and the second off-chip memory is a static random access memory (SRAM).

6. The method of claim 1 further including:
locking the produce index;
reading a value of the produce index;
incrementing the read value based on a size of the packet;
writing the incremented value to the produce index; and
unlocking the produce index.

7. The method of claim 1 further including:
writing the packet to the queue; and
atomically incrementing a produce count stored in an on-chip memory.

8. A method of processing packets, comprising:
determining whether data is stored in a queue of an off-chip memory of a network processor based on a produce count and a consume count, the produce count and the consume count being stored in an on-chip memory of the network processor.

9. The method of claim 8 further including reading multiple packets from the queue if data is determined to be stored in the queue.

10. The method of claim 9 further including:
transmitting a first packet of the multiple packets to a transmit buffer; and
storing a second packet of the multiple packets to an on-chip cache.

11. The method of claim 9 further including:
incrementing the consume count in accordance with the reading of the multiple packets; and
writing the incremented consume count to the on-chip memory.

12. The method of claim 8 further including:
determining whether data is stored in an on-chip cache before determining whether data is stored in the queue; and
reading a packet from the on-chip cache if data is determined to be stored in the on-chip cache.

13. The method of claim 8 further including:
reading the consume count;
reading the produce count; and
subtracting the consume count from the produce count.

14. A method of processing packets, comprising:
reading a produce count from an on-chip memory of a network processor;
reading a consume count from the on-chip memory of the network processor;
subtracting the produce count from the consume count to determine an availability of the queue, the queue having an associated produce index;
locking the produce index;
reading a value of the produce index;
incrementing the read value based on a size of a incoming packet;
writing the incremented value to the produce index;
unlocking the produce index;
writing the incoming packet to the queue while the produce index is unlocked; and
atomically incrementing the produce count.

15. The method of claim 14 further including determining whether data is stored in the queue based on the produce count and the consume count.

16. The method of claim 15 further including reading multiple outgoing packets queue if data is determined to be stored in the queue.

17. The method of claim 15 further including:
determining whether data is stored in an on-chip cache before determining whether data is stored in the queue; and
reading an outgoing packet from the on-chip cache if data is determined to be stored in the on-chip cache.

18. A network processor comprising:
a receive micro-engine to use a first receive thread to determine an availability of a queue, the queue being shared by a plurality of receive threads and having an associated produce index, the receive micro-engine to use the first receive thread to increment the produce index while the produce index is locked, if the queue is determined to be available, and to write an incoming packet to the queue while the produce index is unlocked.

19. The network processor of claim 18 further including an on-chip memory operatively coupled to the receive micro-engine, the on-chip memory to store a produce count and a consume count, the receive micro-engine to use the first receive thread to determine the availability of the queue based on the produce count and the consume count.

20. The network processor of claim 19 further including a transmit micro-engine to use a first transmit thread to determine whether data is stored in the queue based on the produce count and the consume count, the queue being shared by a plurality of transmit threads.

21. The network processor of claim 20 wherein the transmit micro-engine is to use the first transmit thread to read multiple packets from the queue if data is determined to be stored in the queue.

22. The network processor of claim 20 wherein the transmit micro-engine includes an on-chip cache, the transmit micro-engine to use the first transmit thread to determine whether data is stored in the on-chip cache before determining whether data is stored in the queue, and to read an outgoing packet from the on-chip cache if data is determined to be stored in the on-chip cache.

23. The network processor of claim 20 further including a plurality of transmit micro-engines and a plurality of receive micro-engines.

24. The network processor of claim 18 wherein the queue is part of a first off-chip memory and the produce index is stored in a second off-chip memory.

25. A networking architecture comprising:
a first off-chip memory having a plurality of queues;
a second off-chip memory to store a plurality of produce indices corresponding to the plurality of queues; and
a network processor operatively coupled to the off-chip memories, the network processor having a receive micro-engine to use a first receive thread to determine an availability of a queue, the queue being shared by a plurality of receive threads and having an associated produce index, the receive micro-engine to use the first receive thread to increment the produce index while the produce index is locked, if the queue is determined to be available, and to write an incoming packet to the queue while the produce index is unlocked.

26. The networking architecture of claim 25 wherein the network processor further includes an on-chip memory operatively coupled to the receive micro-engine, the on-chip memory to store a produce count and a consume count, the receive micro-engine to use the first receive thread to determine the availability of the queue based on the produce count and the consume count.

27. The networking architecture of claim 26 wherein the network processor further includes a transmit micro-engine to use a first transmit thread to determine whether data is stored in the queue based on the produce count and the consume count, the queue being shared by a plurality of transmit threads.

28. The networking architecture of claim 27 wherein the transmit receive micro-engine is to read multiple packets from the queue if data is determined to be stored in the queue.

29. The networking architecture of claim 27 wherein the transmit micro-engine includes an on-chip cache, the transmit micro-engine to use the first transmit thread to determine whether data is stored in the on-chip cache before determining whether data is stored in the queue, and to read an outgoing packet from the on-chip cache if data is determined to be stored in the on-chip cache.

30. A machine readable storage medium storing a set of instructions capable of being executed by a processor to:
determine an availability of a queue, the queue being shared by a plurality of receive threads and having an associated produce index;
increment the produce index while the produce index is locked, if the queue is determined to be available; and
write a packet to the queue while the produce index is unlocked.

31. The medium of claim 30 wherein the instructions are further capable of being executed to:
read a produce count from an on-chip memory of a network processor;
read a consume count from the on-chip memory of the network processor; and
determine the availability of the queue based on the produce count and the consume count.

32. A machine readable storage medium storing a set of instructions capable of being executed by a processor to:
determine whether data is stored in a queue of an off-chip memory of a network processor based on a produce count and a consume count, the produce count and the consume count being stored in an on-chip memory of the network processor.

33. The medium of claim 32 wherein the instructions are further capable of being executed to read multiple packets if data is determined to be stored in the queue.

34. The medium of claim 33 wherein the instructions are further capable of being executed to:
transmit a first packet of the multiple packets to a transmit buffer; and
store a second packet of the multiple packets to an on-chip cache.
